(19) United States
(12) Patent Application Publication
(10) Pub. No.: US 2026/0044977 A1
(43) Pub. Date: Feb. 12, 2026

(54) METHODS AND SYSTEMS OF TAG LOCATION DETECTION IN AN INVENTORY ENVIRONMENT BASED ON VISUAL ATTRIBUTES OF TAGS USING COMPUTER VISION

(71) Applicant: T-Mobile Innovations LLC, Overland Park, KS (US)

(72) Inventors: Lyle Bertz, Lee’s Summit, MO (US); Robert Butler, Overland Park, KS (US); Zhisheng Chen, Overland Park, KS (US); Rishi Khare, Coppell, TX (US)

(21) Appl. No.: 18/799,878

(22) Filed: Aug. 9, 2024

(51) Int. Cl. G06T 7/70; G06K 19/06; G06Q 10/087; H04B 17/318

(52) U.S. Cl. CPC G06T 7/70; G06Q 10/087; H04B 17/318; G06K 19/06037; G06T 2207/10028

(57) ABSTRACT

A method comprises registering, by an application, a tag identifier received from a tag in an inventory environment with location data indicating a location of the tag based on a visual attribute of the tag, initiating, by the application, a scan of the tag to obtain tag data from the tag and to capture an image depicting the tag by transmitting a signal to the tag after registering the tag identifier with the location data of the tag, and triggering, by the application, activation of a light emitting diode (LED) on the tag to indicate whether a reader device is in a read range of the tag, in which a visual feature of the LED indicates whether the reader device is in the read range of the tag, and wherein the signal is used to activate the LED on the tag.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern inventory environments (e.g., warehouses and retail stores) may store items on behalf of various customers/business enterprises. Each item may be coupled to a tag, such as a Radio Frequency Identification (RFID) tag. Antenna systems and/or reader devices may be positioned throughout the inventory environment. RFID tags may include various components, such as, for example, an integrated circuit for storing and processing information, an antenna for communicating signals, etc. For example, the integrated circuit may include memory for storing tag data (e.g., a unique identifier), a modulator for modulating signals, and circuitry for power management. The RFID tag may receive signals from antenna systems/reader devices to obtain power, obtain power from the received signals, and transmit response back to the reader devices.

### SUMMARY

In an embodiment, a method for determining and managing locations of a plurality of tags in an inventory environment is disclosed. The method comprises receiving, by an application executing on a computer system in an inventory system, tag data from a plurality of tags comprising a first tag and a plurality of second tags, in which the first tag includes one or more light emitting diodes (LEDs) or quick respond (QR) codes and a chip, and the application is executed at a reader device or a management system external to the inventory environment. The method further comprises determining, by the application, location data for each of the plurality of tags based on a received signal strength indicator (RSSI) for each of the plurality of tags, in which the location data comprises three dimensional coordinates of each of the tags, and storing, by the application, the location data of each of the plurality of tags with the tag data received from each of the plurality of tags. The method further comprises capturing, by a camera communicatively coupled to the application, an image depicting the plurality of tags in an area within the inventory environment, identifying, by the application, the first tag in the image based on a visual attribute of the first tag, in which the visual attribute is associated with a feature of the one or more LEDs or one or more QR codes on the first tag, determining, by the application, first location data of the first tag using the visual attribute of the first tag depicted in the image, determining, by the application, that the second tags are within the area in which the first tag is located, and updating, by the application, the location data of each of the second tags to be the first location data of the first tag.

In another embodiment, an inventory system is disclosed. The inventory system comprises one or more tags positioned in an inventory environment and comprising one or more visual attributes, a reader device, a camera, and a data store. The reader device comprises a first processor configured to execute a reader application to initiate a scan of each of the one or more tags, and receive tag data from each of the one or more tags. The camera is positioned within a visual zone of the one or more tags and comprises a second processor configured to execute a camera application to obtain an image depicting the one or more tags, and determine location data for each of the one or more tags using the one or more visual attributes indicated in the image based on a predefined schedule for individually scanning the one or more tags or pre-stored visual attributes of the one or more tags. The data store is configured to register locations of each of the one or more tags by storing the location data for each of the one or more tags with the tag data received from each of the one or more tags based on the predefined schedule or the pre-stored visual attributes of the one or more tags.

In yet another embodiment, a method is disclosed. The method comprises registering, by an application executing at a computer system in an inventory system, a tag identifier received from a tag in an inventory environment with location data indicating a location of the tag based on a visual attribute of the tag, initiating, by the application, a scan of the tag to obtain tag data from the tag and to capture an image depicting the tag by transmitting a signal to the tag after registering the tag identifier with the location data of the tag, and triggering, by the application, activation of a light emitting diode (LED) on the tag to indicate whether a reader device is in a read range of the tag, in which a visual feature of the LED indicates whether the reader device is in the read range of the tag, and wherein the signal is used to activate the LED on the tag.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network including an inventory system with one or more reader devices, one or more cameras, and one or more tags with visual attributes according to various embodiments of the disclosure.

FIGS. 2A and 2B are diagrams illustrating exemplary processes for registering tags with visual attributes using the inventory system of FIG. 1 according to various embodiments of the disclosure.

FIGS. 3A and 3B are diagrams illustrating exemplary processes for updating location data describing a location of tags in the inventory system of FIG. 1 according to various embodiments of the disclosure.

FIG. 4 is a diagram illustrating alerts that may be provided using the tags with visual attributes in the inventory system of FIG. 1 according to various embodiments of the disclosure.

FIG. 5 is a flowchart illustrating a first method of optimizing the inventory system of FIG. 1 according to various embodiments of the disclosure.

FIG. 6 is a flowchart illustrating a second method of optimizing the inventory system of FIG. 1 using registered tags according to various embodiments of the disclosure.

FIG. 7 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, an RFID tag (sometimes referred to herein as simply a “tag”) is a small electronic device that stores data and communicates with antennas and reader devices via radio waves for identification and tracking purposes. Tags may be attached to different types of items, which may enter, pass through, be stored at, or exit different inventory environments. An inventory environment may refer to a location in which items may be stored or located at least temporarily. For example, an inventory environment may be a warehouse or a retail store. An operator of the inventory environment may deploy antennas and/or reader devices at various positions throughout the inventory environment, in a mobile or stationary manner.

Antennas (separate from or part of a reader device) may operate to emit signals (e.g., radio frequency signals) into a region including the items with the tags. The tags within a range of the emitted signals may receive the signals and use the energy from the signals to harvest power at the tag. The tag may then use the power to send data back to reader devices (e.g., in the case of a passive RFID tag without a power source). Once the tags have obtained power, the tags may send various types of data associated with the tag and/or an item coupled to the tag to a reader device. The reader device may receive the response data from the tags, and use the data for various purposes or forward the data to external entities.

U.S. patent application Ser. No. ______, entitled “Methods and Systems of Tag Location Detection in an Inventory Environment based on Audio Attributes of Audio Signals Received from Tags,” by Lyle Bertz, et. al., filed Aug. ______, 2024 (hereinafter referred to as the “Audio Attributes of Audio Signals Patent Application”) is hereby incorporated by reference in its entirety. The Audio Attributes of Audio Signals Patent Application describes enhancing the ability of inventory systems to correlate the data received from the tags with a visual and/or audio attribute of the tag, and to leverage location data provided by cameras and/or microphones to provide a more accurate location of different tags in an inventory environment.

However, in some cases it may be challenging to identify and distinguish between different tags in an inventory environment. For example, reader devices may receive data from multiple tags in a scanning area. However, the users and the reader devices may be unable to identify the tags from which the data is received. This may be because the tags may have a white background, may be fixed to an item with white packaging, and/or may be positioned in the inventory environment against a white background.

To resolve this, tags may be enhanced to include additional components that may help users and reader devices identify the existence of tags in the inventory environment, to ensure that the reader devices scan tags accurately and efficiently. For example, tags may include visual components to aid in identifying the tag, such as, for example, quick response (QR) codes, light emitting diodes (LEDs), sensors, etc. For example, a tag may include the baseline chip (e.g., integrated circuit/antenna) structure as a package, and the package may be visually enhanced to include a QR code printed onto the package or a QR code embodied as multiple LEDs, in which the LEDs may be lit up/colored dynamically to create a pattern. As another example, a tag may include one or more LEDs, which may be preset or programmatically set to emit light at a defined brightness or color for a defined duration upon activation (e.g., upon receiving power). In some cases, the tag may include multiple different visual components (e.g., an LED and a QR code). In this way, tags have evolved to include different visual attributes (e.g., the LEDs and QR codes) that enable enhanced reader devices (e.g., reader devices programmed with computer vision modules, reader devices including depth cameras, etc.) to recognize the presence of tags in an inventory environment.

However, reader devices may still not be enabled to associate the different tags having different visual attributes with the tag data received from the circuit on the tag. For example, the reader device may not be enabled to correlate the data received from the tags with the visual attributes of the tags that are captured in an image by a camera. In addition, the reader device (or a server coupled to the reader device) may only be enabled to determine a location of the tags based on a received signal strength indicator (RSSI) measured using the signals received from the tags. RSSI-based location methods are not only based on complex computations that may require a heavy processing load at reader devices, but these methods also are largely inaccurate (e.g., the determined locations using RSSI-based location methods may have an error range of up to 2-4 feet). Therefore, the inventory systems that include reader devices and cameras to identify and read data from tags with different types of visual attributes are inefficient since the data from the tags may not be correlated with the tags themselves, and ineffective for identifying an accurate location of the tags.

The present disclosure addresses the foregoing technical problems by providing a technical solution in the technical field of inventory tracking, control, and management, by enhancing the ability of inventory systems to correlate the data received from the tags with a visual attribute of the tag and to leverage location data provided by depth cameras to provide a more accurate location of different tags in an inventory environment. In some embodiments, the reader devices in the inventory environment may include or be coupled to a camera device (e.g., depth camera) that may be capable of measuring a distance between the camera and various objects captured in an image and/or determine a location of various objects in the image using the measured distance and a field of view of the camera. An application either at the reader device or a management system in the inventory system may associate tag data received from the tags with the location data of the tags based on the visual attributes on the tags. The location data and visual attributes of the tags may also be used to refine the RSSI-based location data of other tags that may not have visual attributes, as further described herein. Therefore, the embodiments disclosed herein enable a more resource efficient method for accurately identifying a location of the tags in an inventory environment, even when the tags do not necessarily include visual attributes used for image-based location determination.

In some embodiments, an inventory system may include one or more reader devices (e.g., stationary or mobile), antennas (e.g., separate from the reader devices or integrated with the reader devices), cameras (e.g., depth cameras or standard cameras separate from the reader devices or integrated with the reader devices), tags (e.g., RFID tags that may or may not include additional visual attributes), and a management system. The inventory environment (e.g., warehouse, retail store) may include the reader devices, cameras, antennas, and tags, in which the tags may be positioned on racks, pallets, conveyor belts, bins, etc. in the inventory environment. The management system may be provisioned on a computer system within the inventory environment or external to the inventory environment, in which the reader devices and/or cameras may communicate with the management system over a network.

The inventory system may register each of the tags having visual attributes in the inventory environment, to maintain data describing the visual attributes on each of the respective tags and a most recent location of the tags. In an embodiment, each of the tags with visual attributes may be registered individually, one-by-one, according to a predefined schedule. In this embodiment, reader devices and/or cameras may be programmed with the predefined schedule, which may prescribe time intervals, time points, or a frequency during which to individually determine an image-based location of individual tags and receive tag data from the individual tags.

For example, suppose an area of the inventory environment includes a rack with six different storage bins, in which each bin has a fixed tag with an LED (i.e., a visual attribute) on the tag. Thus, the area includes six fixed tags each having an LED programmed to emit light according to a predefined configuration, which may be the same or different across each of the six fixed tags. Each bin may include multiple items affixed to corresponding lightweight tags that may not have an LED (e.g., that may not have any visual attributes or visual markers for depth detection). The antenna/reader device may sequentially light each LED on each of the fixed tags individually, or one-by-one, by transmitting a signal to the tag according to a time indicated in the predefined schedule. The tag may use the power obtained from the signal to activate (e.g., light up) the LED according to a preconfigured instruction for a visual attribute of the light emitted from the LED. The visual attribute may be, for example, a pattern emitted from the LED, a color of the light emitted from the LED, a brightness of the light emitted from the LED, etc. The camera may then capture an image of the activated LED to detect the presence of the tag according to the time indicated in the predefined schedule.

The camera may include a camera application to compute a distance from the camera to the activated LED and/or compute a location (e.g., three dimensional (3D) coordinates) of the activated LED to obtain location data of a first tag. In another embodiment, an application at the reader device and/or an application at an external management system may receive the image and depth data captured by the camera, and compute the distance from the camera to the activated LED and/or the location of the activated LED to obtain location data of the first tag, in some cases, using a classification model. The location data of the first tag may be stored locally at the reader device and/or at the management system. The reader device, camera, and management system may perform these steps individually for each of the six fixed tags with LEDs, until the inventory system has data describing the visual attributes of each of the fixed tags with LEDs, the tag data received from each of the tags, and a most recent location of each of the fixed tags.

In another embodiment, multiple tags with visual attributes in an area may be registered together based on pre-stored data describing the visual attributes on different tags that may be present in the inventory environment and the corresponding tag data for the different tags. In this embodiment, the reader device and camera may not need to individually scan each tag and measure the distance to the activated LED according to a pre-defined schedule. Instead, the reader device and/or management server may be programmed to correlate the identified visual attributes (e.g., the color of the LEDs, brightness of the LEDs, tag background color, arrange of LEDs as a code, etc.) of the captured tags and received tag data with pre-stored visual attributes of different tags. The pre-stored visual attributes of different tags may be previously provided to the management system (e.g., in the form of images of the tags or data describing the visual attributes on the tags), and the management system may store the received visual attributes with tag data received from the tags. For example, the data store may have entries indicating that a tag identifier 1A of a first tag has one LED that lights up in the color green when activated, a tag identifier 1B of a second tag has a printed QR code of a first predefined pattern, a tag identifier 1C of a third tag has a background color of blue, etc.

In this embodiment, the reader device may transmit signals to all six fixed tags to simultaneously activate the LEDs on all six fixed tags and receive tag data from each of the six fixed tags. The camera may then capture an image with the six activated LEDs on all six fixed tags. An application at the inventory system (e.g., the camera application at the camera, the application at the reader device, or the system application at the management system) may then identify the visual attributes of tags in the image (e.g., as opposed to other, non-tag related visual markers and objects in the image). The application may use the identified visual attributes to determine the distance from the camera to each LED and/or determine a location of each LED to obtain location data for each of the tags in the area, in some cases, using a trained classification model system. For example, the classification model system may be trained based on labeled images with visual attributes that are known to be at certain locations or certain distances from the camera, such that the classification model system may be used to accurately predict a location of each of the tags based on the visual attributes of each of the tags. At this stage, the application has obtained an image-based location for each of the tags, and the reader device has separately received the tag data from each of the tags.

The application may compare the image of each of the six activated LEDs with pre-stored visual attributes to identify a match between a currently captured visual attribute and a pre-stored visual attribute to obtain a corresponding tag identifier of the currently captured visual attribute. The application may similarly identify matches for each of the six LEDs to obtain a corresponding tag identifier for each of the six fixed tags. For example, the application may determine that a brightness of an LED on a first tag matches a stored visual attribute of a tag having a tag identifier of 1; the application may determine that a color of an LED on a second tag matches a stored visual attribute of a tag having a tag identifier of 2, the application may determine that a pattern of a QR code on a third tag matches a stored visual attribute of a tag having a tag identifier of 3, etc. The application may then store the determined location of each LED with the tag identifier of each of the six fixed tags as location data for each of the six fixed tags to complete registration of the tags.

Therefore, in both of the aforementioned embodiments, an initial registration for each of the tags with visual attributes of the tags may be performed to store data describing the visual attributes of each tag, with tag data (e.g., a tag identifier) of each tag, and with the most recent location data of each tag. The most recent location data stored at registration may be an image-based location of the tag, which may be determined using an image captured by a depth camera, as described above. The image-based location of the tag may be far more accurate than an RSSI-based location of the tag. Nevertheless, the application may additionally calculate the RSSI-based location of not only the six fixed tags in the area, but also calculate the RSSI-based location of all of the lightweight tags (e.g., tags without visual attributes) in each of the six bins. For example, the reader device may determine the location data for all of the lightweight tag using an RSSI-based location method based on a signal strength of the received signal carrying the tag data from each of the lightweight tags.

However, as mentioned above, the RSSI-based locations of the tags are largely inaccurate (e.g., sometimes having an error of up to several feet). Therefore, the application may refine the location data of the tags in the inventory environment when image-based location data may be available and relevant to the tags. For example, in the situation described above, there are multiple lightweight tags without visual attributes in each of the six bins, and RSSI-based location data may be stored in the data store for each of the lightweight tags. However, each of the six bins may also be associated with image-based location data according to the aforementioned registration process of each of the six fixed tags with LEDs. The image-based location data may refer to the determined distance between a camera and the visual attribute on the tag, and/or a determined location of the visual attribute on the tag. In this case, the data store may include location data for all of the tags (the six fixed tags with LEDs being associated with image-based location data and the lightweight tags being associated with RSSI-based location data).

The system may maintain one or more rules for refining the RSSI-based location data to use more accurate image-based location data. A rule may define various location areas or three-dimension bounding boxes (e.g., each of the bins may correspond to a location area), such that when RSSI-based location data and image-based location data is included in the same location area, then the RSSI-based location data may be updated to be the image-based location data. The application may determine, according to the rule, that the location data for at least a subset of the identified lightweight tags (i.e., the RSSI-based location) may be refined or updated based on the location data for one of the fixed tags. In this way, the data store may reflect that all the lightweight tags inside each bin has the same location data as the fixed tag on each respective bin.

In some embodiments, the response from tag with a visual attribute may be recalibrated to ensure optimal performance and accurate detection. For example, the camera may capture an image of the visual attribute of each tag periodically and update the registration to reflect any changes to the visual attribute. The reader device may also scan the tag to retrieve a signal back from the tag with the tag data, and the reader device may record the signal strength, read range, and any other issues (e.g., missed reads or inconsistent data). The recalibrated image and/or signal may be used to update the data stored at the data store in association with each tag, to ensure that tags may be read accurately and the location data for the tags have been updated accurately.

In some embodiments, the reader device may trigger the visual attributes of the tags to be dynamically updated based on various factors to provide alerts for users. For example, when a tag includes an LED, the LED may be dynamically set in response to a scan by the reader device based on a distance between the reader device and the tag. The dynamic setting of the LED may indicate different types of data to the user of the reader device (e.g., whether the reader device is in the optimal read range of the tag or outside the optimal read range of the tag, whether the reader device is transmitting sufficient or insufficient power to the tag, etc.). For example, suppose an optimal read range from a tag is between 100 centimeters (cm) and 400 cm from the tag. As the user approaches the tag with the reader device, the reader device may simultaneously and continuously transmit signals to the tag and trigger a camera to capture an image of the LED on the tag and identify a distance between the camera and the LED. The LED may be programmed to be activated or light up at a specific color or according to the instructions indicating the visual attribute or lighting pattern based on a distance between the camera and the LED (e.g., the LED may light up in red when the distance between the camera and the LED is between 50 cm-100 cm, light up in green when the distance between the camera and the LED is between 100 cm-400 cm, and light up in yellow when the distance between the camera and the LED is greater than 400 cm). In this way, the user may see the light/pattern of the LED to determine whether the reader device is in the optimal read range of a tag to-be detected.

Accordingly, the embodiments disclosed herein enable tag data received from different tags to be correlated with image-based location data determined using a visual attribute present on the tags. Inventory systems may thus maintain far more accurate location data of the tags using image-based location data, as opposed to RSSI-based location data. The system described herein can be used to receive inventory items into an inventory environment and to monitor the location and re-location of the inventory items within the inventory environment. The system can be used to locate inventory items that are required for picking and dispatching to complete a fulfillment order. The system can be used to tally up totals of different categories or models of inventory that are currently in stock.

The embodiments disclosed herein also enable a method whereby nearby lightweight tags that do not include distinguishable visual attributes may rely on the more accurate image-based location data than the RSSI-based location data. Therefore, the embodiments disclosed herein enable a more efficient use of the resources in the inventory system using more accurate locations of the task, thereby increasing inventory system efficiency and capacity.

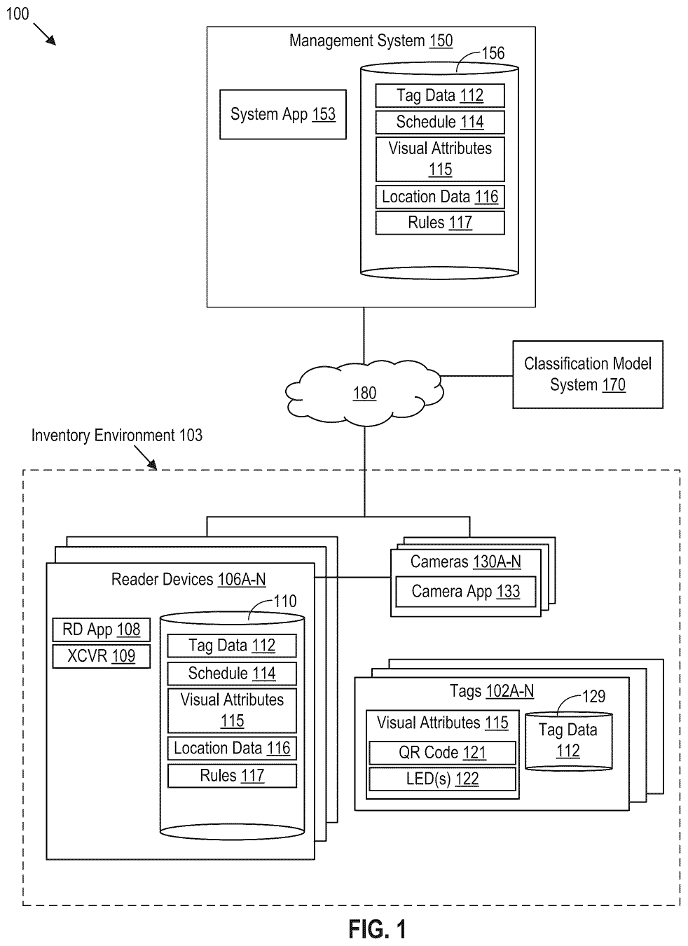

Turning now to FIG. 1, a communication network 100 is described. The communication network 100 includes an inventory environment 103, a management system 150, a classification model system 170, and a network 180. The inventory environment 103 includes one or more tags 102A-N, one or more reader devices 106A-N, and one or more cameras 130A-N. The network 180 may be one or more private networks, one or more public networks, or a combination thereof. While the management system 150 is shown in FIG. 1 as being separate from network 180, in some embodiments, it should be appreciated that the management system 150 may be part of the network 180. In the embodiment shown in FIG. 1, an inventory system may include the management system 150, the reader devices 106A-N, cameras 130A-N, and tags 102A-N.

The tags 102A-N may each be small devices used in inventory systems to store and transmit data wirelessly to reader devices 106A-N. Tags 102A-N may be coupled to (e.g., affixed to) different items and thus may be used for tracking and identifying the items, enabling efficient inventory management and asset tracking in various inventory environments 103 (e.g., warehouses, retail stores, centers, etc.). Each tag 102A-N includes a microchip (e.g., an integrated circuit with processing and memory resources) for data storage and processing and an antenna for communication. The microchip of the tags 102A-N may include a data store 129 (e.g., one or more memories), which may store tag data 112 associated with the tag 102A-N. The tag data 112 may include a variety of data, such as, for example, a tag identifier (e.g., a unique serial number or electronic product code (EPC) distinguishing different tags 102A-N from one another), item information (e.g., data about the item to which the tag 102A-N is attached), manufacturer or supplier information about the item, logistics data, usage data (e.g., records and when and where the tag 102A-N has been scanned), etc.

One or more of the tags 102A-N may include visual attributes 115 used for visual sensing by a camera 130A-N, in which the visual attributes 115 may be any visually discernable visual object or pattern of known sizes and/or shapes. The visual attributes 115 on the tags 102A-N may include, for example, one or more QR codes 121, LEDs 122, LEDs 122 that are lit according to a predefined pattern (e.g., a multi-LED pattern configuration lit according to a pattern (e.g., QR code 121)), polka dotted patterns, striped patterns, different color schemes, patterns (e.g., of LEDs 122 or colors), and/or other visual markers with a known size and/or shape that may be used for object identification using a camera 130A-N. In some cases, the LEDs 122 may be arranged on a tag 102A-N to embody a QR code 121 when lit-up.

The reader devices 106A-N may be electronic devices or computer systems configured to transmit signals to the tags 102A-N to both power the tags 102A-N and trigger the tags 102A-N to respond to the signal with at least a portion of the tag data 112 stored on the tag 102A-N. Each of the reader devices 106A-N include an application 108 and a radio transceiver 109 (shown as “XCVR 109” in FIG. 1). The application 108 may be instructions stored on a memory of the reader device 106A-N, which may be executed by a processor of the reader device 106A-N to scan the tags 102A-N, trigger the cameras 130A-N, and communicate tag data 112 and other data upstream to the management system 150. The radio transceiver 109 may include radio equipment enabling the reader devices 106A-N to communicate with other devices in the inventory environment 103 and/or to the management system 150 over the network 180.

The reader devices 106A-N may also include a data store 110 (e.g., one or more memories) for storing tag data 112, schedules 114, visual attributes 115, location data 116, and rules 117. The schedules 114 may indicate predefined time intervals or time points for a reader device 106A-N to initiate scanning one or more tags 102A-N and capture an image depicting visual attributes 115 of the one or more tags 102A-N.

The tag data 112 may be received from the different tags 102A-N in the inventory environment 103. For example, the tag data 112 may include the tag identifier received from the tags 102A-N. The visual attributes 115 may describe the visual features/markers on each of the tags 102A-N in the inventory environment 103 that may be used by a camera 130A-N as a target (e.g., signature) for object detection and location determination. For example, the visual attributes 115 may indicate whether the tag 102A-N includes an LED 122 or a QR code 121, and/or where the LED(s) 122 or QR code(s) 121 are positioned on the tag 102A-N. The visual attributes 115 may indicate a quantity and/or pattern of LEDs 122 on the tag 102A-N, a color of each LED 122 on the tag 102A-N, a brightness level of each LED 122 on the tag 102A-N, etc. The visual attributes 115 may indicate the pattern of the QR code 121 on the tag 102A-N, a position of the QR code 121 on the tag 102A-N, a color of the printed QR code 121 on the tag 102A-N, whether the QR code 121 is printed on the tag 102A-N in ink or embodied as a pattern of LEDs 122, etc. The visual attributes 115 may indicate a background color of the tag 102A-N, a border color of the tag 102A-N, one or more features of a visual mark on the tag 102A-N, etc. The visual attributes 115 may be stored at the data store 110 and/or data store 156 at the management system 150 prior to registration of the tags 102A-N or after registration of the tags 102A-N. When the visual attributes 115 are stored after registration of the tags 102A-N, the visual attributes 115 may indicate the visual attributes 115 of each tag 102A-N that are captured in an image by the camera 130A-N during registration. When the visual attributes 115 are stored prior to registration of the tags 102A-N, the visual attributes 115 may indicate the visual attributes 115 of each tag 102A-N, which may be manually entered by an operator, or previously captured by a prior image of the tag 102A-N.

The location data 116 may include 3D coordinates or a general location range of the tags 102A-N. The location data 116 may be categorized as either RSSI-based location data or image-based location data. RSSI-based location data may be determined for lightweight tags 102A-N that do not have distinguishable visual attributes 115 that may be used by a camera 130A-N as a target for object detection, and thus the reader device 106A-N (or management system 150) may have determined a location of these lightweight tags 102A-N based on a signal strength of the signal received from the lightweight tags 102A-N. Image-based location data may be determined for tags 102A-N that have visual attributes 115, and thus the camera 130A-N and the reader device 106A-N may determine a location of these tags 102A-N based on an image depicting the visual attributes 115 of the tags 102A-N.

In an embodiment, the data store 110 may include records or entries for each identified tag 102A-N in the inventory environment 103. A record for a tag 102A-N may include the corresponding tag data 112 received from the tag 102A-N, the visual attributes 115 on the tag 102A-N (if any), the location data 116 of the tag 102A-N (e.g., RSSI-based or image-based), and any other data associated with the tag 102A-N. In some cases, the location data 116 may indicate a most recently determined location of the tag 102A-N and prior locations of the tag 102A-N as the tag 102A-N moves through the inventory environment 103, and may indicate a timestamp or duration of the tag 102A-N being in the prior location.

The rules 117 may include location grouping rules (e.g., logic, code, conditions, etc.), which may be used by the application 108 at the reader device 106A-N (or the system application 153 at the management system 150) to determine whether and how to update location data 116 for a tag 102A-N. For example, the rules 117 may define location areas or 3D bounding boxes, in which location data 116 for a tag 102A-N is to be updated (e.g., from an RSSI-based location to an image-based location).

The cameras 130A-N may be integrated into the reader devices 106A-N, or may be standalone separate devices that may be communicatively coupled to the reader devices 106A-N. In an embodiment, each of the cameras 130A-N may be depth cameras, which are imaging devices that capture 3D information about a distance between the camera 130A-N and an object in a field of view (e.g., a visual attribute 115 on a tag 102A-N). In this case, the cameras 130A-N may include a camera application 133, which may be instructions stored on a memory of the camera 130A-N and executable by a processor of the camera 130A-N.

The camera application 133 may capture images depicting one or more tags 102A-N in an inventory environment and, in an embodiment, may determine distances between the camera 130A-N and the visual attributes 115 on the tags 102-N captured by the camera 130A-N. The cameras 130A-N may also include various depth imaging equipment, such as, for example, an infrared projector, an infrared sensor, a standard red green blue (RGB) camera, etc. For example, the cameras 130A-N may capture images in which each pixel contains depth information, representing the distance from the camera 130A-N to the object at the target, or representing a location of the object in space (e.g., as 3D coordinates). The image captured by a camera 130A-N may in some cases be a depth map or a 3D image, with distances reflected for each pixel. The camera application 133 may transmit captured images (e.g., as a continuous feed) to the management system 150, for tag detection, distance/location computation, and data storage.

In another embodiment, cameras 130A-N may be standard cameras for capturing, storing, and transmitting images, but the cameras 130A-N may not have depth calculation capabilities (e.g., may not be capable of calculating a distance from the camera 130A-N to each pixel captured in the image). In this case, the cameras 130A-N may transmit the images (e.g., as a continuous feed) to the management system 150. The system application 150 at the management system may use a trained AI model (e.g., the classification model system 170 further described below) to determine a distance between the camera 130A-N and the identified tag 102A-N and/or determine a location of the identified tag 102A-N (as opposed to relying on depth computation capabilities of cameras 130A-N).

In an embodiment, an intensity or appearance of the LED(s) 122 (e.g., visual attributes 115) on a tag 102A-N may aid the camera application 133 in determining the distance from the camera 130A-N to the tag 102A-N (in some cases, using a computer vision method at the classification model system 170). In an embodiment, the camera application 133 (in some cases, and/or the reader application 108 and/or the system application 153) may estimate the power received/harvested at the tag 102A-N based on an appearance of the LED(s) 122 on the tag 102A-N (e.g., brightness, color, arrangement etc.). For example, an LED 122 that is emitting light at a decreased power level (relative to prior versions of the activated LED 122), the reader application 108 may determine that the power harvested by the tag 102A-N may be less than prior activations of the tag 102A-N. In one embodiment, the tag 102A-N may be programmed to use the harvested power to activate the LED(s) 122 using the power, or the tag 102A-N may be programmed to activate the LED(s) 122 according to a certain parameter (e.g., brightness level, specific color, arrangement, etc.) based on the power harvested at the tag 102A-N. That is, the tag 102A-N may either use the harvested power to activate the LEDs 122 (as bright as possible in a predefined color scheme or based on a predefined pattern), or the tag 102A-N may evaluate the harvested power to programmatically signal RSSI information using the LED(s) 122 to the reader device 106A-N. In this way, the camera 130A-N may capture an image depicting the LED(s) 122 activated according to the specified parameter, and evaluate the LED(s) 122 to determine the RSSI intensity at the tag 102A-N. As described herein, the RSSI may be used to determine a location of the tag 102A-N. The camera application 133, application 108 at the reader device 106A-N, and/or the system application 153 at the management system 150 may store the evaluated parameters of the LED(s) 122, determined RSSI intensity, and RSSI-based location of the tag 102A-N in the data stores 110 and/or 156. In an embodiment, the visual attribute 115 of LEDs 122 on a tag 102A-N may be a grid of LEDs, and based on the signal received to power the tag 102A-N, the tag 102A-N may be programmed to illuminate the arrangement of LEDs 122 to display a pattern (e.g., a particular QR code 121).

In an embodiment, the camera application 133 may identify an orientation of the tag 102A-N and/or identify a particular tag 102A-N in a cluster of tags 102A-N based on the visual attribute 115. In some cases, the tags 102A-N may include multiple visual attributes 115 (e.g., an LED 122 and a QR code 121), and the camera application 133 may rely on the QR code 121 for detection when the LED 122 is not lighting up or is not sufficiently bright.

The management system 150 may be a device, UE, computer, or computer system, with various types of resources that may be interworked to control the operations of the reader devices 106A-N and cameras 130A-N to maintain accurate data regarding tags 102A-N in the inventory environment 103. The management system 150 may include a processor, a memory, a radio transceiver, and other hardware or software components depending on the type of computer system running the management system 150. The management system 150 may include a system application 153, which may include instructions stored on a memory of the management system 150 and executable by a processor of the management system 150. The system application 153 may communicate with the reader devices 106A-N, cameras 130A-N, and classification model system 170, as further disclosed herein.

For example, system application 153 may programmatically generate the schedules 114 for reader devices 106A-D to execute when registering the tags 102A-N, or receive the schedules 114 from an operator. Similarly, the system application 153 may programmatically generate the rules 117, or receive the rules 117 from the operator. The system application 153 may push the schedules 114 and rules 117 to one or more reader devices 106A-N in the inventory environment 103 over the network 180.

The system application 153 may receive tag data 112 associated with different tags 102A-N from the reader devices 106A-N, and may determine the location data 116 for the tags 102A-N based on the tag data 112. When the camera 130A-N is a depth camera capable of computing depth at various visual markers in an image, the camera 130A-N may transmit (a stream of) captured images with depth data for each pixel in each captured image to the system application 153 over the network 180. The system application 153 may identify the different tags 102A-N in the image based on the visual attributes 115 detected in the image, in some cases, using the classification model system 170, which as further described below may be trained to facilitate identification of tags 102A-N with or without visual attributes 115 in the image. The system application 153 may then determine the actual location data 116 (e.g., x, y, z coordinates) for each tag 102A-N captured in the image based on the depth data (e.g., the distance from the camera 130 to the identified tags 102A-N).

In contrast, when the camera 130A-N is not a depth camera, the camera 130A-N may transmit captured images (without depth data) to the system application 153 over the network 180. Again, the system application 153 may identify the different tags 102A-N in the image based on the visual attributes 115 detected in the image, in some cases, using the classification model system 170, which as further described below may be trained to facilitate identification of tags 102A-N with or without visual attributes 115 in the image. In this embodiment, the system application 153 may also determine the actual location data 116 (e.g., x, y, z coordinates) for each tag 102A-N captured in the image using the classification model system 170, which as further described below may be trained to determine locations of objects identified in an image and/or determine distances to the objects identified in the image.

The management system 150 may also include a data store 156 (e.g., one or more memories, distributed or co-located). The data store 156 may store the tag data 112, schedules 114, visual attributes 115, location data 116, and rules 117, similar to the data store 110 of the reader devices 106A-N.

The classification model system 170 may be a server or system of servers that may employ artificial intelligence (AI) methods, classification methods, or computer vision methods for classifying input images using advanced hardware and software resources. Computer vision is a field of artificial intelligence that enables computers to interpret and understand visual information from images and videos, in a way that mimics human vision. For example, computer vision involves techniques for acquiring, processing, analyzing, and interpreting visual data to perform tasks like object detection, image classification, and facial recognition. While FIG. 1 illustrates the classification model system 170 as being separate from the management system 150, in some embodiments, the classification model system 170 may be provisioned in the management system 150. The classification model system 170 may run neural networks and AI models that have been previously trained with extensive training data to recognize patterns and features to perform object detection, identify and locate objects within images, perform image classification/labeling, etc. For example, the classification model system 170 may be trained to identify objects or visual markers (e.g., visual attributes 115) in a received image to identify corresponding tags 102A-N in the image. The classification model system 170 may also be trained to determine distances to the identified objects/visual markers/tags 102A-N in the image.

The classification model system 170 may be built using convolutional neural networks (CNNs), for example, and may scan images, detect features like edges, textures, and shapes, and use these features to classify objects detected in the images (e.g., as either a visual attribute 115 on a tag 102A-N or not). The classification model system 170 may be trained using a large dataset of labeled images from different angles, orientations, and distances from tags 102A-N. The labeled images identify known objects or visual attributes 115 on different types of tags 102A-N, identify known distances between the visual attributes 115 and the camera 130A-N, and/or identify known locations of the visual attributes 115 in an inventory environment 103. Once trained, the classification model system 170 may be used to classify new, unseen images by processing the images through the network layers of the model 170, extracting the learned features, and making predictions based on the detected patterns to identify visual attributes 115 and determine distances/locations to the visual attributes 115.

In an embodiment, the camera application 133, application 108, or the system application 153 may provide captured images of tags 102A-N with visual attributes 115 to the classification model system 170. The images of tags 102A-N may be captured from different angles, orientations, and distances based on the position and orientation of the camera 130 capturing the image, and the training of the classification model system 170 may enable the system 170 to categorize the images captured from different angles, orientations, and distances together to identify tags 102A-N in the images and determine locations of the tags 102A-N in the images. The classification model system 170 may run various algorithms on received images to identify the visual attributes 115 in the images to identify the corresponding tags 102A-N in the images. In some cases, the classification model system 170 may run various algorithms on received images to determine the location of the visual attributes 115 in the images to obtain the location data 116 of the tags 102A-N in the images. The classification model system 170 may pass location data 116 back to the reader devices 106A-N and/or to the management system 150, and the reader devices 106A-N and/or management system 150 may store the location data 116 in association with corresponding tag data 112.

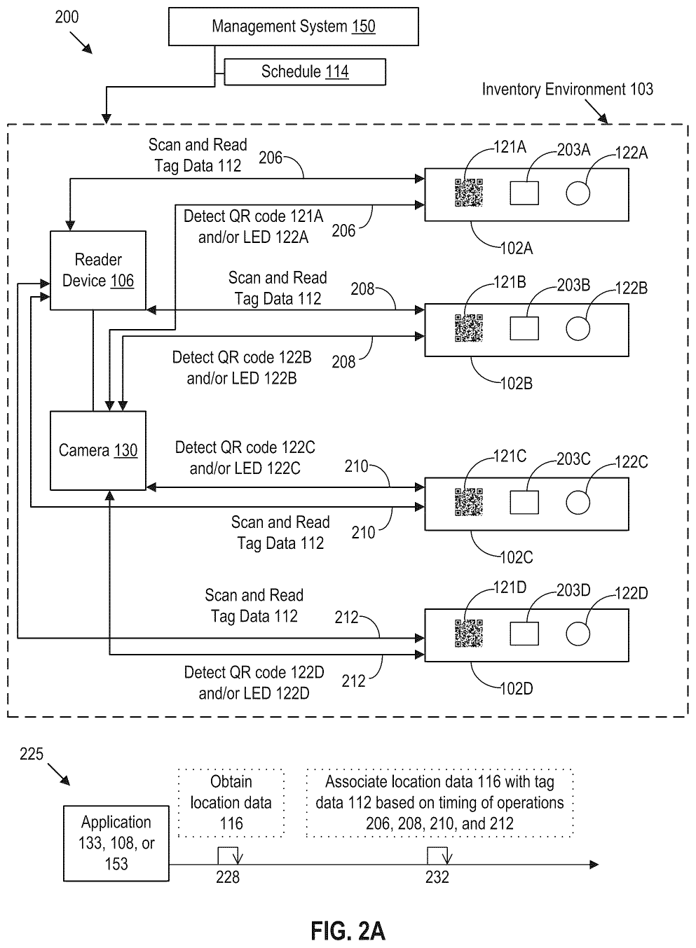

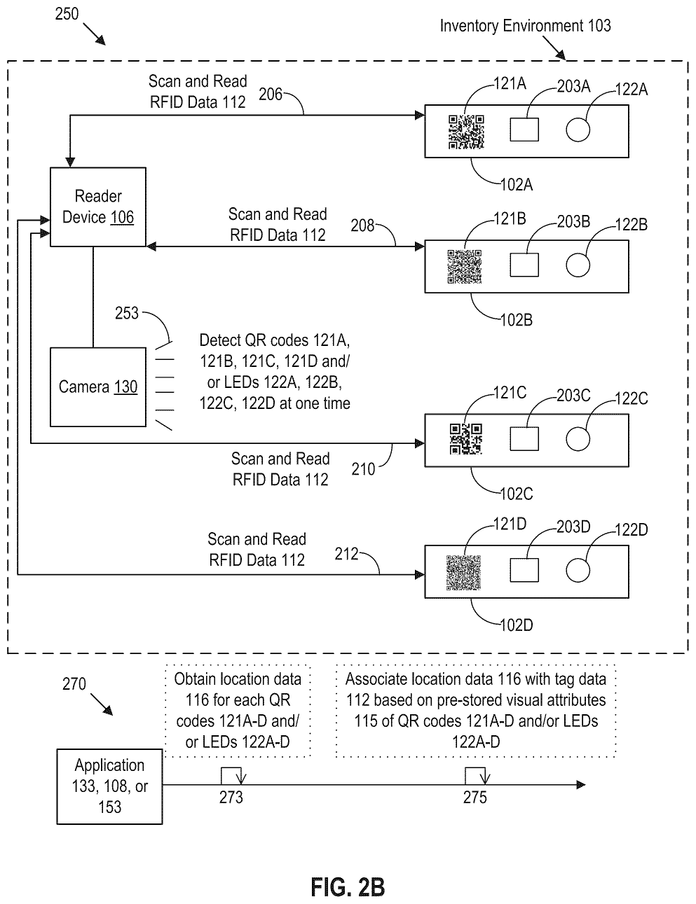

Referring now to FIGS. 2A and 2B, shown are two embodiments of registering tags 102A-N in an inventory environment 103. In particular, FIG. 2A illustrates an inventory system 200 including a reader device 106A-N (hereinafter referred to as “reader device 106”) and camera 130A-N (hereinafter referred to as “camera 130”) that operate to sequentially register individual tags 102A-D separately. FIG. 2B illustrates an inventory system 250 including the reader device 106 and the camera 130 that operate to register multiple tags 102A-D together (as opposed to individually).

Turning now specifically to FIG. 2A, shown is an inventory system 200 including the reader device 106, the camera 130, and an exemplary four tags 102A, 102B, 102C, and 102D. While the inventory system 200 is shown as only including one reader device 106, one camera 130, and four tags 102A-D, it should be appreciated that the inventory system 200 may include any number of reader devices 106, cameras 130, and tags 102A-D. The reader device 106, the camera 130, and the tags 102A-D shown in FIG. 2A are positioned within the inventory environment 103, such that the combination of the camera 130 and the reader device 106 are positioned within the read zone and the visual zone of the tags 102A-D. The read zone is an area or distance from the tags 102A-D in which the reader device 106 is capable of accurately communicating with the tags 102A-D to receive data from the tags 102A-D, and the visual zone of the tags 102A-D is an area or distance from the tags 102A-D in which the camera 130 is capable of completely and clearly capturing the visual attributes 115 on the tags 102A-D. It should be appreciated that the read zone and the visual zone for tags 102A-D may be the same area or may be different areas, particularly if visual obstacles are present between the tags 102A-D and the camera 130 and reader device 106.

As mentioned above, the inventory system 200 is programmed to sequentially register individual tags 102A-D separately, in some embodiments, according to a predefined schedule 114. The schedule 114 may indicate specific time intervals, time windows, or time points, during which time to sync the reader device 106 and the camera 130 to coordinate scanning and performing location detection of tags 102A-D individually. For example, the schedule 114 may indicate a first time window during which the reader device 106 is to complete scanning an individual tag 102A, 102B, 102C, or 102D (e.g., transmit signals to the tag 102A-D and receive tag data 112 from the tag 102A-D) and during which the camera 130 is to capture an image (still image or video) depicting visual attributes 115 of the individual tag 102A, 102B, 102C, or 102D, a second time window during which the reader device 106 and the camera 130 is to perform the same for another individual tag 102A, 102B, 102C, or 102D, a third time window during which the reader device 106 and the camera 130 is to perform the same for yet another individual tag 102A, 102B, 102C, or 102D, and so on. In this case, the different time windows may be the same time duration such that the reader device 106 and the camera 130 are essentially configured to perform tag scanning and image capturing across different tags 102A-D at a predefined frequency based on the same time duration. In one case, the reader device 106 may be programmed to scan the different tags 102A-D according to the schedule 114 (e.g., send signals to the different tags 102A-D according to a predefined frequency), and the camera 130 may be programmed to capture an image with a respective tag 102A-D at the same or similar predefined frequency (e.g., a predefined number of milliseconds to account for the delay between a tag 102A-D receiving a signal and using the signal to power the visual attributes 115 of the tag 102A-D).

In another embodiment, the reader device 106 may communicate data with the management system 150 after scanning a tag 102A-D such that the management system 150 instructs the camera 130 to capture an image of the tag 102A-D and perform location detection of the tag 102A-D. For example, the reader device 106 may scan a tag 102A-D according to the schedule 114, and transmit a message including a scan time, an identification of the reader device 106, an identification of an antenna that sent the signal to the tag 102A-D, a port associated with the reader device 106 and/or antenna, and a tag identifier (obtained from the tag data 112) of the tag 102A-D, to the management system 150. The system application 153, upon receiving this message, may instruct the camera application 133 to capture an image with the tag 102A-D identified in the message to perform location detection and identify the location of the tag 102A-D. The camera application 153 may then transmit a second message including a shot time that the camera 130 captured the image of the tag 102A-D (which may be slightly different from the reader device 106 scan time), the identification of the reader device 106, the identification of the antenna and port, the tag identifier, and the captured image. In this case, the camera application 133, application 108, or the system application 153 may perform the computations to determine the location data 116 of the tag 102A-D using the image depicting the visual attributes 115 of the tag 102A-D.

In the example shown in FIG. 2A, the reader device 106 and/or the camera 130 may receive the schedule 114 from the management system 150, after the management system 150 programmatically determines the schedule 114 (e.g., based on the type of reader device 106 and/or camera 130) or receives the schedule 114 from an operator of the management system 150. Once the reader device 106 and/or camera 130 receive and store/program the schedule 114, the reader device 106 and camera 130 may begin individually registering the tags 102A-D.

As shown in FIG. 2A, each of the tags 102A-D may include the chip 203A-D and one or more visual attributes 115, such as, for example, a QR code 121A-D and/or one or more LEDs 122A-D, respectively. As shown in FIG. 2A, tag 102A includes a chip 203A (e.g., including the integrated circuit, processor, memory, antenna, etc.), a QR code 121A, and one or more LEDs 122A. Tag 102B includes a chip 203B, a QR code 121B, and one or more LEDs 122B. Tag 102C includes a chip 203C, a QR code 121C, and one or more LEDs 122C. Tag 102D includes a chip 203D, a QR code 121D, and one or more LEDs 122D. While FIG. 2A illustrates each of the tags 102A-D as including both QR codes 121A-D and LEDs 122A-D, it should be appreciated that tags 102A-D may not necessarily include both a QR code 121A-D and an LED 122A-D (e.g., the tag 102A-D may include either a QR code 121A-D or an LED 122A-D). It should also be appreciated that the tags 102A-D may include any other type of visual attribute 115 or marker that the cameras 130 may use for tag 102A-D identification.

In the embodiment shown in FIG. 2A, the reader device 106 may individually scan each tag 102A-D and the camera 130 may individually detect each tag 102A-D according to a time synchronization indicated in the schedule 114, as described above. For example, the reader device 106 and the camera 130 may first perform operation 206. At operation 206, the reader device 106 may, based on a time indicated in the schedule 114, scan the tag 102A and the camera 130 may, also based on the time indicated in the schedule 114, detect the QR code 121A and/or LED 122A (e.g., visual attributes 115) of the tag 102A. The reader device 106 may scan the tag 102A by instructing an antenna of the reader device 106 or another separate antenna communicatively coupled to the reader device 106 to transmit a signal (e.g., a modulated signal with electromagnetic energy) to the tag 102A, and the tag 102A may use the energy from the signal to obtain power. Once powered up, the tag 102A may activate (e.g., light up) the LED 122A, and transmit tag data 112 stored at the memory of the chip 203A to the reader device 106. The camera 130 may detect the QR code 121A and/or LED 122A of the tag 102A by capturing an image (e.g., still or video image) depicting the QR code 121A and/or LED 122A of the tag 102A.

At this stage, an application (e.g., the camera application 133, application 108 at the reader device 106, and/or the system application 153 at the management system 150) may perform method 225. Turning now to method 225, the application may perform operation 228 to obtain (e.g., determine/calculate) the location data 116 of the tag 102A (e.g., 3D coordinates of the tag 102A). For example, the camera application 133 and/or the application 108 at the reader device 106 may use the captured image, depth information of the captured image, and in some cases the classification model system 170 to identify the visual attribute 115 in the image, and then determine a distance to or location of the visual attribute 115. In this case, operation 228 may be performed using object identification and location methods enabled in the camera 130 and/or reader device 106. Alternatively, the camera application 133 may transmit the image and depth information to the system application 153, and the system application 153 may use the captured image, depth information of the captured image, and in some cases the classification model system 170 to identify the visual attribute 115 in the image, and then determine a distance to or location of the visual attribute 115. In this case, operation 228 may be performed using the classification model system 170 (e.g., by providing the image as input into the system 170, and receiving the location data 116 back from the system 170).

Then, at operation 232, either the camera application 133, application 108 at the reader device 106, or system application 153 at the management system 150 may associate the obtained location data 116 (e.g., image-based location calculated using the image captured by the camera 130) with the tag data 112 (e.g., received by the reader device 106 from the tag 102A and including a tag identifier of the tag 102A) based on the time synching of performing operation 206 as indicated in the schedule 114. For example, the application 133, 108, or 153 may determine time interval during which the reader device 106 and camera 130 scanned the tag 102A based on the schedule 114, determine a scan time of scanning the tag 102A and receiving the tag data 112 from the tag 102A, and a shot time of capturing the image depicting the QR code 121A and LED 122A of tag 102A for location analysis. The application 133, 108, and/or 153 may then determine whether the scan time and the shot time are within the range of the time interval of the schedule 114 associated with reading the tag 102A. When the scan time and the shot time are within the range of the time interval of the schedule 114 associated with reading the tag 102A, the application 133, 108, and/or 153 may register the tag data 112 (e.g., tag identifier) of the tag 102A with the identified visual attributes 115 of the tag 102A (e.g., the QR code 121A and the LED 122A) and the determined location data 116 (e.g., image-based location) of the tag 102A in the data store 110 and/or 156.

After completing method 225 to register tag 102A, the reader device 106 and camera 130 may perform operations 208, 210, 212 and method 225 for each tag 102B, 102C, and 102D individually to register each of tag 102B, 102C, and 102D with the inventory system 200 (e.g., in data stores 110 and/or 156). For example, the reader device 106 and the camera 130 may perform operation 208 to scan the tag 102B and capture an image depicting QR code 121B and/or LED 122B (e.g., visual attributes 115) of the tag 102B based on a time indicated in the schedule 114. Then, the application 133, 108, and/or 153 may perform method 225 to register the tag 102B with the inventory system 200. Next, reader device 106 and the camera 130 may perform operation 210 to scan the tag 102C and capture an image depicting QR code 121C and/or LED 122C (e.g., visual attributes 115) of the tag 102C based on a time indicated in the schedule 114. Then, the application 133, 108, and/or 153 may perform method 225 to register the tag 102C with the inventory system 200. Next, reader device 106 and the camera 130 may perform operation 212 to scan the tag 102D and capture an image depicting QR code 121D and/or LED 122D (e.g., visual attributes 115) of the tag 102D based on a time indicated in the schedule 114. Then, the application 133, 108, and/or 153 may perform method 225 to register the tag 102D with the inventory system 200. In this way, the inventory system 200 in FIG. 2A is programmed to register each of tags 102A, 102B, 102C, and 102D individually.

Turning now to FIG. 2B, shown is the inventory system 250, which is similar to the inventory system 200 of FIG. 2A, and includes the reader device 106, the camera 130, and the exemplary four tags 102A, 102B, 102C, and 102D. However, unlike FIG. 2A, the inventory system 250 is programmed to register the tags 102A-D together, as opposed to individually. The registration of the tags 102A-D shown in FIG. 2B may not be based on a schedule 114, but instead may be based on pre-stored visual attributes 115 of different tags 102A-D that may be positioned in the inventory environment 103.

In this case, an operator may pre-scan each of the tags 102A-D to obtain the tag data 112 from the tags 102A-D and obtain the visual attributes 115 of tags 102A-D, and then provide the tag data 112 of the tags 102A-D and the identified visual attributes 115 of the tags 102A-D to the management system 150 for storage at the data store 156. This pre-scan and storage at the management system 150 may be performed prior to the tags 102A-D entering the inventory environment 103 or being coupled to items destined for storage at the inventory environment 103.

For example, an operator may operate a device (which may be the management system 150) to gather the tags 102A-D (before or after the tags 102A-D have been coupled to respective items), perform a scan on the tags 102A-D to receive the tag data 102A-D from the chips 203A-D of the tags 102A-D, and capture images of the tags 102A-D depicting the QR codes 121A-D and LEDs 122A-D on each of the tags 102A-D. The operator may then provide the obtained tag data 112 of the tags 102A-D with the captured images of each of the tags 102A-D to the management system 150, such that the system application 153 at the management system 150 receives an image of a tag 102A-D and the visual attributes 115 of the tag 102A-D with the tag data 112 of the respective tag 102A-D.

The system application 153 may then identify the visual attributes 115 (e.g., the QR codes 121A-D and LEDs 122A-D on each of the tags 102A-D) using image processing modules programmed at the management system 150 or by providing the images as input to the classification model system 170. The system application 153 may then obtain, either using the local image processing modules or from the classification model system 170, data (e.g., images or text) specifically associated with each tag 102A-D. For example, the system application 153 may obtain pictures of the different patterns on the QR codes 121A-D integrated respectively with each of the tags 102A-D, data indicating the colors or brightness levels of the LEDs 122A-D on each of the tags 102A-D, etc. The system application 153 may store the pictures and data of each tag 102A-D with the tag data 112 of the respective tag 102A-D as the visual attributes 115 of the tag 102A-D. For example, the data store 156 may have an entry for each tag 102A-D, including the tag data 112 for each respective tag 102A-D and the data identifying the visual attributes 115 on each respective tag 102A-D.

As another example, the system application 153 may obtain pictures of a color or brightness of each LED 122A-D on each of the tags 102A-D. The system application 153 may store the pictures or values representing the color or brightness of each LED 122A-D on each of the tags 102A-D with the tag data 112 of the respective tag 102A-D as the visual attributes 115 of the tag 102A-D. For example, the data store 156 may have an entry for each tag 102A-D, including the tag data 112 for each respective tag 102A-D and the visual attributes 115 (e.g., the pictures or values representing the color or brightness of each LED 122A-D) on each respective tag 102A-D. In this way, the management system 150 may have tag data 112 and data describing the visual attributes 115 of each tag 102A-D that may enter an inventory environment 103, prior to the tags 102A-D being scanned and detected for location purposes.

Once the tags 102A-D enter the inventory environment 103, the tags 102A-D may be scanned for identification and location purposes. As shown in FIG. 2B, the reader device 106 may scan the tags 102A-D simultaneously or individually, at operations 206, 208, 210, and 212. At operation 253, the camera 130 may then capture an image depicting all of the tags 102A-D in potentially a single image, and the visual attributes 115 (e.g., the QR codes 121A-D and LEDs 122A-D) on each of the tags 102A-D may be completely and clearly depicted in the image.

At this stage, the camera application 133, application 108 at the reader device 106, and/or the system application 153 at the management system 150 may perform method 270. Turning now to method 270, either the camera application 133, the application 108 at the reader device 106 when the camera 130 is part of the reader device 106, or the system application 153 at the management system 150 when the camera 130 transmits the captured image to the management system 150, may perform operation 273 to obtain (e.g., determine/calculate) the location data 116 of all of tags 102A-D (e.g., 3D coordinates of the tags 102A-D) depicted in the image. This operation may be performed based on object identification and location methods enabled in the camera 130, and in some cases, using the classification model system 170 (e.g., by providing the image as input into the system 170, and receiving the location data 116 back from the system 170).

Then, at operation 275, either the camera application 133, application 108 at the reader device 106, or system application 153 at the management system 150 may associate the obtained location data 116 (e.g., image-based location calculated using the image captured by the camera 130) with the tag data 112 (e.g., received by the reader device 106 from the tag 102A-D and including a tag identifier of the tag 102A-D) based on the previously stored visual attributes 115 of all of the tags 102A-D.

For example, the application 133, 108, or 153 may collect the tag data 112 from each of the tags 102A-D, the location data 116 of the identified visual attributes 115 (e.g., the QR codes 121A-D and/or LEDs 122A-D) on each of the tags 102A-D in the image captured by the camera 130, and images or data describing the identified visual attributes 115 (e.g., the QR codes 121A-D and/or LEDs 122A-D) on each of the tags 102A-D in the image. The application 133, 108, or 153 may compare currently identified visual attributes 115 with the stored visual attributes 115 to identify a match between the currently identified visual attributes 115 and the stored visual attributes 115. When a match between a currently identified visual attribute 115 in the image and a stored visual attribute 115 is identified (e.g., when a match between a QR code 121A-D in a tag 102A-D and stored QR code is identified), the application 133, 108, or 153 may obtain the tag data 112 or the tag identifier in the entry with the matching stored visual attribute 115. The application 133, 108, or 153 may then have identified the entries in the data store 156 corresponding to the tags 102A-D in the image. The application 133, 108, or 153 may obtain the location data 116 calculated based on the image for each of the tags 102A-D (from operation 273) and add the location data 116 to the entry with the matching stored visual attribute 115, such that the added location data reflects the most recent location 116 of the tags 102A-N.

The registration of the tags 102A-N may be completed when the location data 116 for the tags 102A-N have been added to the entries of the tags 102A-N in the data store 156. In some cases, the system application 153 may transmit the entries for the tags 102A-D with the tag data 112, visual attributes 115, and location data 116 for each of the tags 102A-D to the reader devices 106 in the inventory environment 103. The reader devices 106 may store the entries in the data store 110.

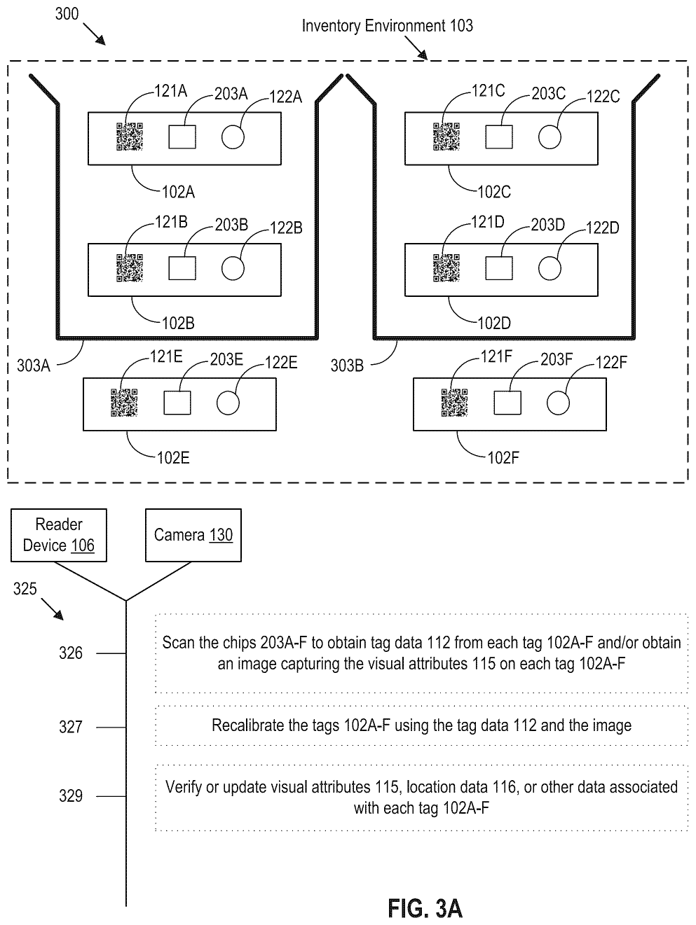

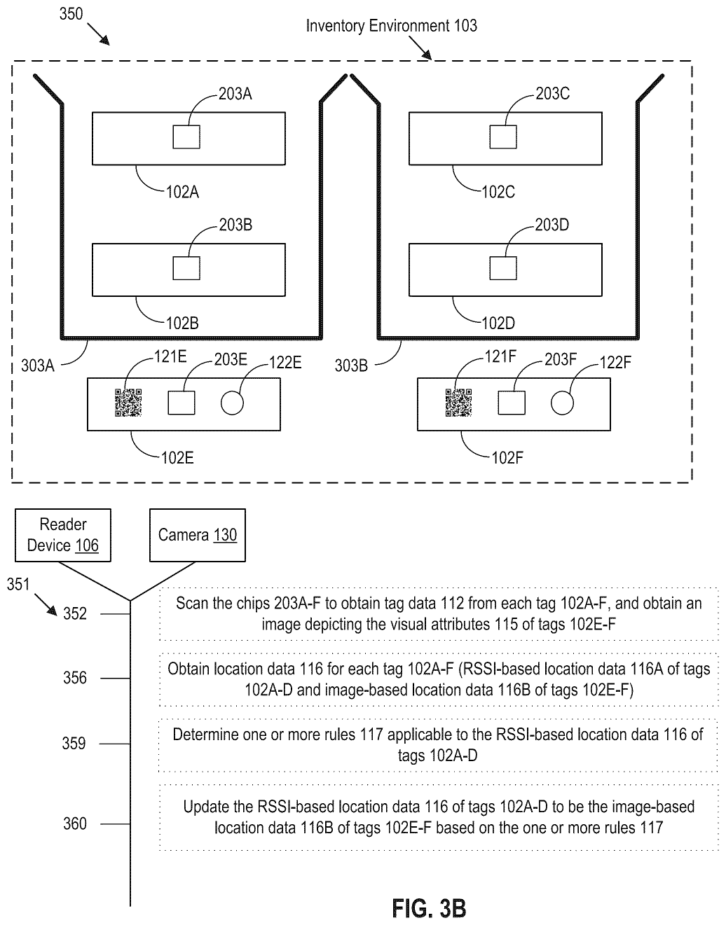

Referring now to FIGS. 3A and 3B, shown are diagrams of two embodiments of updating location data 116 of tags 102A-D in an inventory environment 103. In particular, FIG. 3A illustrates an inventory system 300 including a reader device 106 and camera 130 that operate to update location data 116 for tags 102A-F, in which each of the tags 102A-F have visual attributes 115 detectable by the camera 130. FIG. 3B illustrates an inventory system 350 including a reader device 106 and a camera 130 that operate to update location data 116 for tags 102A-F, in which only tags 102E and 102F have visual attributes 115 detectable by the camera 130.

Turning now to FIG. 3A, shown is an inventory system 300 including the reader device 106, the camera 130, and an exemplary six tags 102A, 102B, 102C, 102D, 102E, and 102F. The reader device 106, the camera 130, and the tags 102A-D are positioned within the inventory environment 103. The management system 150 may communicate with the reader device 106 and the camera 130 over the network 180.

As mentioned above, each of the six tags 102A, 102B, 102C, 102D, 102E, and 102F include distinguishable visual attributes 115 detectable by the camera 130. Tag 102A includes the chip 203A and QR code 121A and/or LED 122A (e.g., the visual attributes 115 on the tag 102A). Similarly, tag 102B includes the chip 203B and QR code 121B and/or LED 122B, tag 102C includes the chip 203C and QR code 121C and/or LED 122C, tag 102D includes the chip 203D and QR code 121D and/or LED 122D, tag 102E includes the chip 203E and QR code 121E and/or LED 122E, and tag 102F includes the chip 203F and QR code 121F and/or LED 122F.

FIG. 3A illustrates the current location of each of tags 102A-F. For example, as shown in FIG. 3A, the tags 102A-D are located in the two areas 303A-B in the inventory environment 103, and tags 102E-F are located outside of the two areas 303A-B. Specifically, tag 102A and 102B are located within area 303A, and tag 102C and tag 102D are located within area 303B. Tag 102E may be considered as located within the area 303A as well even though FIG. 3A illustrates tag 102E as being positioned adjacent to and underneath area 303A. Similarly, tag 102F may be considered as located within the area 303B as well even though FIG. 3A illustrates tag 102F as being positioned adjacent to and underneath area 303B.

Each of the areas 303A and 303B may correspond to 3D areas or zones within the inventory environment 103 in which one or more tags 102A-D (coupled to items) may be at least temporarily located for a period of time. For example, area 303A and 303B may correspond to separate but adjacent storage bins on a rack in the inventory environment 103. Each storage bin (e.g., each area 303A and 303B) may at least temporarily store items attached to the tags 102A-D. To this end, the tags 102A-D may be mobile within the inventory environment 103, and may not always remain stored in the areas 303A-B, but the storage bins themselves may remain fixed. Meanwhile, the tags 102E and 102F may remain fixed in a position relative to each of the storage bins, and thus fixed in a position to identify each of the areas 303A-B. For example, the tag 102E may be positioned on the front of a shelf on the rack supporting the storage bin for area 303A, and tag 102F may be positioned on the front of the shelf on the rack supporting the storage bin for area 303B.

Turning now to method 325 in FIG. 3A, it may be assumed that the tags 102A-F and the most recent location data 116 for each of the tags 102A-F may have already been registered with the reader device 106 and/or the management system 150. It may also be assumed that the most recent location data 116 for the tags 102A-F may be image-based location data 102A-F, and thus reflect relatively accurate locations of the tags 102A-F, since each of the tags 102A-F have distinguishable visual attributes 115.

At operation 326, the reader device 106 and the camera 130 may perform a scan of the tags 102A-F in the inventory environment 103 to obtain tag data 112 from each tag 102A-F and/or obtain (e.g., capture) an updated image of the visual attributes 115 (e.g., QR codes 121A-F and/or LEDs 122A-F) on each of the tags 102A-F. The scan of the tags 102A-F may involve the reader device 106 or antenna communicatively coupled to the reader device 106 to transmit a signal to the tags 102A-F, and then receive tag data 112 from each of the tags 102A-F. The camera 130 may then capture an updated image depicting the visual attributes 115 of each of the tags 102A-F. The camera application 133, the application 108 at the reader device 106, and/or the system application 153 may perform the image processing steps (in some cases using the classification model system 170) to obtain updated location data 116 for each of the visual attributes 115, and thus for each of the tags 102A-F.

At operation 327, the signals containing the tag data 112 received by scanning each of the tags 102A-F and/or the image capturing any updates to the visual attributes 115 of each of the tags 102A-F may be used to recalibrate the tags 102A-F. For example, the image depicting the latest version of the visual attributes 115 may identify changes to the originally registered visual attributes 115 (e.g., a scratch on the QR code, diminished brightness of an LED), and the latest version of the visual attributes 115 may be used to update the registered visual attributes 115 of the tags 102A-F. The signal received with the tag data 112 may also be used by the reader device 106 to record updates to the signal received from the tags 102A-F (e.g., the strength, RSSI intensity, power, read range, and any other issues (e.g., missed reads or inconsistent data) associated with the tags 102A-F).

At operation 329, the reader device 106 may use the recalibration to verify and/or update the visual attributes 115, location data 116, and/or other data associated with each tag 102A-F. For example, when the registered location data 116 of tag 102A was associated with a first position in the inventory environment 103, but at a subsequent time, the tag 102A was moved to the storage bin in area 303A, the recalibration of the tag 102A may be used to update the location data 116 of tag 102A to be the image-based location of the tag 102A in the area 303A.

Turning now to FIG. 3B, shown is the inventory system 350, which is similar to the inventory system 300 of FIG. 3A in that the tags 102A and 102B are positioned in a first storage bin in area 303A, tag 102E is positioned on a rack and in association with the area 303A, tags 102C and 102D are positioned in a second storage bin in area 303B, and tag 102F is positioned on a rack and in association with the area 303B. However, unlike inventory system 300 of FIG. 3A, the tags 102A, 102B, 102C, and 102D are lightweight tags that do not include any visual attributes 115 that may be used by the camera 130 to identify a location of the tags 102A-D. Tags 102E and 102F however do still include visual attributes 115 (e.g., QR codes 121E-F and/or LEDs 122E-F) detectable by the camera 130.

Turning now to method 351 in FIG. 3B, it may be assumed that the tags 102A-F and the most recent location data 116 for each of the tags 102A-F may have already been registered with the reader device 106 and/or the management system 150. It may also be assumed that the most recent location data 116 for lightweight tags 102A-D may be RSSI-based location data (e.g., computed based on a signal strength received from the tags 102A-D), while the most recent location data 116 for tags 102E-F may be image-based location data (e.g., determined based on an image depicting the visual attributes 115 of the tags 102E-F).

At operation 352, the reader device 106 may scan the chips 203A-F in tags 102A-F to obtain tag data 112 from each of the tags 102A-F, and the camera 130 may obtain an image capturing the tags 102E-F, only depicting the visual attributes 115 (e.g., QR codes 121E-F and/or LEDs 122E-F) of tags 102E-F, since tags 102A-D do not include any distinguishable visual attributes 115.

At operation 356, the camera application 133, application 108 at the reader device 106, and/or the system application 153 at the management system 150 may determine updated location data 116 for each of the tags 102A-F. For example, the application 133, 108, and/or 153 may calculate the location data 116 for each of the lightweight tags 102A-D based on the signal strength of the signal carrying the tag data 112 received from each of the tags 102A-D. This location data 116 for tags 102A-D may be RSSI-based location data 116A, which may have a much greater error rate than image-based location data 116B. Meanwhile, the application 133, 108, and/or 153 (in some cases, using the classification model system 170) may determine the location data 116 for each of the tags 102E-F based on the image depicting the visual attributes 115 of tags 102E-F. This location data 116 for tags 102E-F may be the image-based location data 116B, which may be more accurate than the RSSI-based location data 116A.

The reader device 106 and/or the management system 150 may determine whether the RSSI-based location data 116A for tags 102A-D applies to a rule 117. For example, the reader device 106 and/or the management system 150 may maintain a first rule 117 indicating that RSSI-based location data 116A in area 303A may be updated to image-based location data 116B associated with the same area 303A (assuming the location of the tag 102E is associated with the same area 303A since the tag 102E is positioned adjacent to and underneath the area 303A or even within area 303A). In addition, the reader device 106 and/or the management system 150 may maintain a second rule 117 indicating that RSSI-based location data 116A in area 303B may be updated to image-based location data 116B associated with the same area 303B (assuming the location of the tag 102F is associated with the same area 303B since the tag 102F is positioned adjacent to and underneath the area 303B or even within area 303B).

At operation 359, the reader device 106 and/or the management system 150 may determine a rule 117 applicable to the determined RSSI-based location data 116A for tags 102A-D. As mentioned above, the reader device 106 and/or the management system 150 may maintain two rules 117 applicable to areas 303A and 303B, such that the RSSI-based location data 116A for tags 102A-B is to be updated to the image-based location data 116B of tag 102E, while the RSSI-based location data 116A for tags 102C-D is to be updated to the image-based location data 116B of tag 102F. At operation 360, the reader device 106 and/or the management system 150 may apply the rules 117 to update the RSSI-based location data 116A for tags 102A-B to the image-based location data 116B of tag 102E and update the RSSI-based location data 116A for tags 102C-D to the image-based location data 116B of tag 102F.

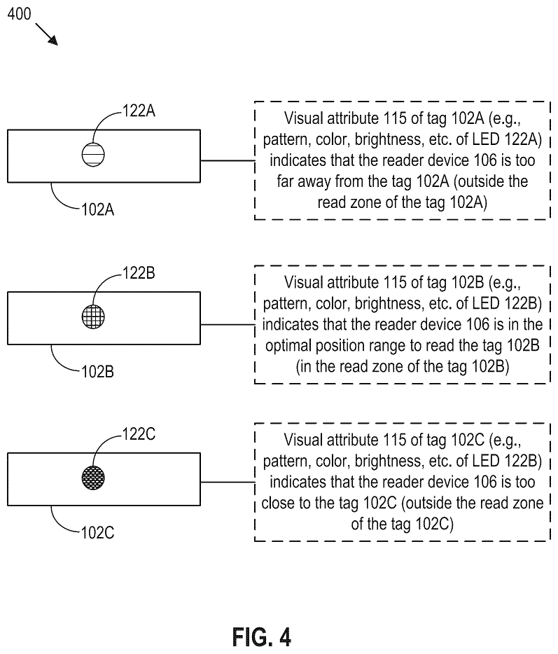

Referring now to FIG. 4, shown is a diagram illustrating examples of different types of alerts 400 that may be displayed using the visual attributes 115 on three exemplary tags 102A, 102B, and 102C according to various embodiments of the disclosure. In the example shown in FIG. 4, the tags 102A-C include one LED 122A-C, respectively. However, it should be appreciated that the tags 102A-C may include any number of LEDs 122 and/or other types of visual attributes 115. Each of the tags 102A-C may be configured to display different visual features on the LED 122A-C as alerts 400, respectively, based on data associated with a reader device 106 transmitting signals to the tags 102A-C. While the tags 102A-C shown in FIG. 4 are separate tags, it should be appreciated that a single tag 102A-C may display the alerts shown in FIG. 4 at different times.

The alerts 400 may be triggered dynamically based on various factors, and in particular, in response to a radio frequency signal received from a reader device 106. In an embodiment, a color, brightness, pattern of blinking, or other feature of the LEDs 122A-C may be dynamically set based on a reader device 106, or more specifically, based on a distance between the reader device 106 and the tag 102A-C. For example, as shown in FIG. 4, the LED 122A on tag 102A includes a first visual feature to indicate first information to the user of the reader device 106, the LED 122B on tag 102B includes a second visual feature to indicate second information to the user of the reader device 106, and the LED 122C on tag 102C includes a third visual feature to indicate third information to the user of the reader device 106.

For example, the indicated information may relate to whether the reader device 106 is in the optimal read zone of the tag 102A-C. Referring specifically now to tag 102A in FIG. 4, as the user with the reader device 106 approaches the tag 102A, the LED 122A on the tag 102A may display the first visual feature shown in FIG. 4 to indicate that the reader device 106 is too far away from the tag 102A (e.g., outside of the read range of the tag 102A). For example, the tag 102A, or the chip 203A of tag 102A, may be preconfigured to set the LED 122A to display the first visual feature based on a detected distance between the reader device 106/camera 130 and the tag 102A, which may be determined by the reader device 106/camera 130. The reader device 106 may then transmit a radio frequency signal to tag 102A to trigger the LED 122A to display the first visual feature based on the detected distance. For example, the first visual feature may be the LED 122A being activated in the color red, to indicate that the reader device 106 is too far away from the tag 102A.

Referring specifically now to tag 102B, as the user with the reader device 106 approaches the tag 102B, the LED 122B on the tag 102B may display the second visual feature shown in FIG. 4 to indicate that the reader device 106 is at an optimal distance from the tag 102B to read the tag 102B (e.g., inside of the read zone of the tag 102B). For example, the tag 102B, or the chip 203B of tag 102B, may be preconfigured to set the LED 122B to display the second visual feature based on a detected distance between the reader device 106/camera 130 and the tag 102B, which may be determined by the reader device 106/camera 130. The reader device 106 may then transmit a radio frequency signal to tag 102B to trigger the LED 122B to display the second visual feature based on the detected distance. For example, the second visual feature may be the LED 122B being activated in the color green, to indicate that the reader device 106 is inside the read zone of the tag 102B.

Referring specifically now to tag 102C, as the user with the reader device 106 approaches the tag 102C, the LED 122C on the tag 102C may display the third visual feature shown in FIG. 4 to indicate that the reader device 106 is too close to the tag 102C (e.g., outside of the read zone of the tag 102B). For example, the tag 102C, or the chip 203C of tag 102C, may be preconfigured to set the LED 122C to display the third visual feature based on a detected distance between the reader device 106/camera 130 and the tag 102C, which may be determined by the reader device 106/camera 130. The reader device 106 may then transmit a radio frequency signal to tag 102C to trigger the LED 122C to display the third visual feature based on the detected distance. For example, the third visual feature may be the LED 122C being activated in the color yellow, to indicate that the reader device 106 is too close to the tag 102C.

The information displayed on the LEDs 122A-C may also signal other types of information. For example, the visual features on the LEDs 122A-C may be dynamically set to indicate predefined visual features based on a power level of a tag 102A-C, based on received signal intensity of the tag 102A-C, based on a type of reader device 106, etc.

In another embodiment, the LEDs 122A-C may be multi-LED configurations (e.g., each tag 102A-C includes a region with multiple LEDs). Different ones of the LEDs may be lit up to display different types of information. For example, the multi-LED configurations may display different patterns (or even QR codes 121) based on a distance between the reader device 106 and the tag 102A-C. For example, one pattern may be displayed on the multi-LED configuration to display the first visual feature, another pattern may be displayed on the multi-LED configuration to display the second visual feature, and yet another pattern may be displayed on the multi-LED configuration to display the third visual feature.

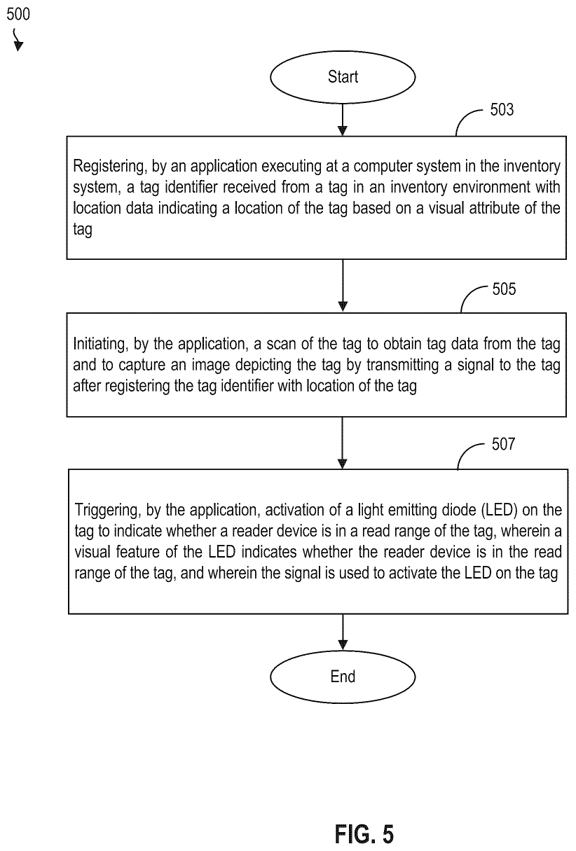

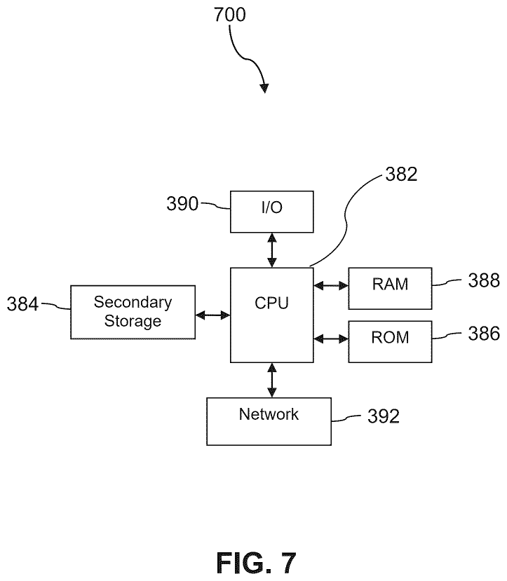

Turning now to FIG. 5, shown is a method 500 for optimizing performance of an inventory system 200, 250, 300, 350 by associating tags 102A-F (hereinafter referred to as “tags 102”) with image-based location data 116B according to various embodiments of the disclosure. Method 500 may be implemented by an inventory system (e.g., the inventory system 200, 250, 300, 350). In embodiments, the method 500 may be implemented using a computer system with components as shown in FIG. 7. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order. Method 500 may be performed by an application executing at a computer system, and the application may refer to the camera application 133 at the camera 130, the application 108 at the reader device 106, and/or the application 153 at the management system 150.

At step 503, method 500 comprises registering, by the application, a tag identifier (e.g., in the tag data 112) received from a tag 102 in an inventory environment 103 with location data 116 indicating a location of the tag 102 based on a visual attribute 115 associated with the tag 102 (or another tag 102 in an area 303A-B with the tag 102). At step 505, method 500 comprises initiating, by the application, a scan of the tag 102 to obtain tag data 112 from the tag 102 and to capture an image depicting the tag 102 by transmitting a signal to the tag 102 after registering the tag identifier with the location data 116 of the tag 102. At step 507, method 500 comprises triggering, by the application, activation of LED 122A-F (hereinafter referred to as “LED 122”) on the tag 102 to indicate whether a reader device 106 is in a read range of the tag 102. The read range may refer to a distance from the tag 102 corresponding to a read zone of the tag 102 (or an area around the tag 102 in which the tag 102 may accurately and clearly communicate with the reader device 106). A visual feature of the LED 122 indicates whether the reader device 106 is in the read range of the tag 102, and the signal is used to activate the LED 122 on the tag 102.

Method 500 may further comprise additional attributes and/or steps not explicitly shown in FIG. 5. In an embodiment, registering the tag identifier of tag 102 with the location data 116 of the tag comprises initiating, by the application, a prior scan of the tag 102 at a first time according to a predefined schedule 114 to read the tag identifier from the tag 102, capturing, by a camera 130 in the reader device 106, an image depicting the tag 102 and the LED 122 on the tag 102 at the first time according to the predefined schedule 114, determining, by the application, the location data 116 of the tag 102 based on a position of the LED 122 on the tag 102, and storing, by the application, the tag identifier with the location data 116 at a data store 110, 156 in the inventory system 200, 250, 300, 350. This embodiment of registering the tags 102 is described above with reference to FIG. 2A.

In another embodiment, registering the tag identifier of tag 102 with the location data 116 of the tag comprises initiating, by the application, a prior scan of the tag 102 to read the tag identifier from the tag 102, capturing, by a camera 130 in the reader device 106, an image depicting the tag 102 and the LED 122 on the tag 102, determining, by the application, the location data 116 of the tag 102 based on a position of the LED 122 on the tag 102, comparing, by the application, a visual attribute 115 of the LED 122 on the tag 102 with a pre-stored visual attribute 115 of a plurality of LEDs 122 on a plurality of different tags 102 stored at a data store 156 in the management system 150 to determine the tag identifier corresponding to the visual attribute 115 of the LED 122 of the tag 102, and storing, by the application, the tag identifier with the location data 116 at the data store 110, 156. This embodiment of registering the tags 102 is described above with reference to FIG. 2B.

In an embodiment, initiating, by the application, the scan of the tag 102 comprises transmitting the signal to the tag 102, and receiving the tag data 112 from the tag 102, in which the tag data 112 comprises the tag identifier. In an embodiment, method 500 may further comprise determining, by the application, the location data 116 based on a signal strength of a signal carrying the tag data 112 received from the tag 102, and storing, by the application, the location data 116 based on the signal strength in the data store.

In an embodiment, method 500 may further comprise re-calibrating, by the application, the tag 102 by periodically capturing and storing images depicting the tag 102 and the LED 122 on the tag 102, and receiving the tag data 112 from the tag 102. In an embodiment, method 500 may further comprise registering, by the application, a second tag identifier received from a second tag 102 in the inventory environment 103 with the location data 116 indicating the location of the tag 102 based on a rule 117. The rule 117 indicates that location data 116 for all tags 102 in an area 303A-B including the location of the tag 102 and a signal strength-based location (e.g., RSSI-based location data 116A) of the second tag 102 is to be set to the location data 116 of the tag 102. In an embodiment, the visual feature of the LED 122 is a predefined color.

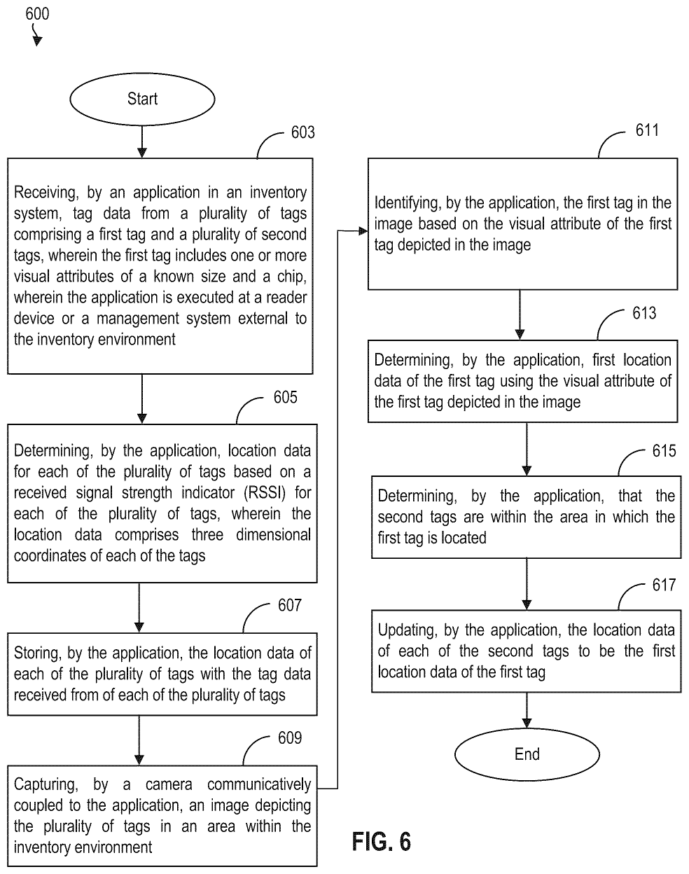

Turning now to FIG. 6, shown is a method 600 for managing locations of tags 102 in an inventory environment 103 according to various embodiments of the disclosure. Method 500 may be implemented by an inventory system (e.g., the inventory system 200, 250, 300, 350). In embodiments, the method 600 may be implemented using a computer system with components as shown in FIG. 7. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order. Method 500 may be performed by an application executing at a computer system, and the application may refer to the camera application 133 at the camera 130, the application 108 at the reader device 106, and/or the application 153 at the management system 150.

At step 603, method 600 comprises receiving, by the application, tag data 112 from a plurality of tags 102 comprising a first tag 102 and a plurality of second tags 102 (e.g., lightweight tags). The first tag 102 includes a visual attribute 115 (e.g., one or more LEDs 122 or QR codes 121) and a chip 203A-F (hereinafter referred to as a “chip 203”). The application is executed at a reader device 106 or a management system 150 external to the inventory environment 103. The second tags 102 may not include any visual attributes 115 detectable by a camera 130.

At step 605, method 600 comprises determining, by the application, location data 116 for each of the plurality of tags 102 based on a received signal strength indicator (RSSI) of signals received from each of the plurality of tags 102. The location data 116 comprises three dimensional (3D) coordinates of each of the tags 102. At step 607, method 600 comprises storing, by the application, the location data 116 of each of the plurality of tags 102 with the tag data 112 received from of each of the plurality of tags 102.

At step 609, method 600 comprises capturing, by a camera 130 communicatively coupled to the application, an image depicting the plurality of tags 102 in an area 303A-B within the inventory environment 103. At step 611, method 600 comprises identifying, by the application, the first tag 102 in the image based on the visual attribute 115 of the first tag 102. For example, the visual attribute 115 is associated with a feature of the one or more LEDs 122 or one or more QR codes 121 on the first tag 102. At step 613, method 600 comprises determining, by the application, first location data 116 of the first tag 102 using the visual attribute 115 of the first tag 102 depicted in the image.

At step 615, method 600 comprises determining, by the application, that the second tags 102 (e.g., the lightweight tags) are within the area 303A-B in which the first tag 102 is located. At step 617, method 600 comprises updating, by the application, the location data 116 of each of the second tags 102 to be the first location data 116 of the first tag.

Method 600 may further comprise additional attributes and/or steps not explicitly shown in FIG. 6. In an embodiment, the second tags 102 exclude visual attributes 115 (e.g., LEDs 122 and QR codes 121). In an embodiment, determining the location data 116 for each of the plurality of tags 102 based on the RSSI of each of the plurality of tags 102 comprises measuring, by the application, a strength of a signal including the tag data 112 received from each of the plurality of tags 102, in which the RSSI for each of the plurality of tags 102 is based on the strength of the signal received from each of the plurality of tags 102, and the RSSI is based on a distance between a tag 102 and the reader device 106, determining, by the application, the distance between each of the plurality of tags 102 and the reader device based on the RSSI for each of the plurality of tags 102, and determining, by the application, a location of each of the plurality of tags 102 based on the distance between each of the plurality of tags 102 and the reader device 106, in which the location data 116 for each of the plurality of tags 102 comprises the location of each of the plurality of tags 102. In an embodiment, the RSSI for each of the plurality of tags 102 may be converted to a distance between each of the plurality of tags 102 and the reader device 106 using predefined equations and models. The RSSI-based location detection may involve, for example, placing one or more reader devices 106 at known locations, measuring RSSI values from the signals received from the tags 102, converting the RSSI values to distances based on the known location of the readers, and in some cases, applying trilateration with other known data to estimate the coordinates of a tag 102.

In an embodiment, the camera 130 is a depth camera, and the image includes depth information for each pixel of the image to measure a distance from the camera 130 to the visual attribute 115 of the first tag 102, and the first location data 116 of the first tag 102 identifies a location of the first tag 102 based on the distance from the camera 130 to the visual attribute 115 of the first tag 102. In an embodiment, the visual attribute 115 of the first tag 102 comprises at least one of an arrangement of the one or more LEDs 122 to create a pattern, a color of the one or more LEDs 122 when lit, a brightness of the one or more LEDs 122 when lit, a background color of the first tag 102, or the one or more QR codes 121 printed on the first tag 102.

FIG. 7 illustrates a computer system 700 suitable for implementing one or more embodiments disclosed herein. In an embodiment, cameras 130, reader devices 106, and/or management system 150, etc., may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for determining and managing locations of a plurality of tags in an inventory environment using computer vision, wherein the method comprises:
receiving, by an application executing on a computer system in an inventory system, tag data from a plurality of tags comprising a first tag and a plurality of second tags, wherein the first tag includes a visual attribute of a known size and a chip, wherein the application is executed at a reader device or a management system external to the inventory environment;
determining, by the application, location data for each of the plurality of tags based on a received signal strength indicator (RSSI) for each of the plurality of tags, wherein the location data comprises three dimensional coordinates of each of the tags;
storing, by the application, the location data of each of the plurality of tags with the tag data received from each of the plurality of tags;
capturing, by a camera communicatively coupled to the application, an image depicting the plurality of tags in an area within the inventory environment;
identifying, by the application, the first tag in the image based on the visual attribute of the first tag depicted in the image;
determining, by the application, first location data of the first tag using the visual attribute of the first tag depicted in the image;
determining, by the application, that the second tags are within the area in which the first tag is located; and
updating, by the application, the location data of each of the second tags to be the first location data of the first tag.

2. The method of claim 1, wherein the second tags exclude visual attributes.

3. The method of claim 1, wherein determining the location data for each of the plurality of tags based on the RSSI of each of the plurality of tags comprises:
measuring, by the application, a strength of a signal including the tag data received from each of the plurality of tags, wherein the RSSI for each of the plurality of tags is based on the strength of the signal received from each of the plurality of tags, wherein the RSSI is based on a distance between a tag and a reader device;
determining, by the application, the distance between each of the plurality of tags and the reader device based on the RSSI for each of the plurality of tags; and
determining, by the application, a location of each of the plurality of tags based on the distance between each of the plurality of tags and the reader device, wherein the location data for each of the plurality of tags comprises the location of each of the plurality of tags.

4. The method of claim 1, wherein the camera is a depth camera, and wherein the image includes depth information for each pixel of the image to measure a distance from the camera to the visual attribute of the first tag, wherein the first location data of the first tag identifies a location of the first tag based on the distance from the camera to the visual attribute of the first tag.

5. The method of claim 1, wherein the visual attribute of the first tag comprises at least one of an arrangement of the one or more light emitting diodes (LEDs) to create a pattern, a color of the one or more LEDs when lit, a brightness of the one or more LEDs when lit, a background color of the first tag, or the one or more quick respond (QR) codes printed on the first tag.

6. An inventory system, comprising:
one or more tags positioned in an inventory environment and comprising one or more visual attributes;
a reader device positioned within a read zone of the one or more tags and comprising a first processor configured to execute a reader application to:
initiate a scan of each of the one or more tags; and
receive tag data from each of the one or more tags;
a camera positioned within a visual zone of the one or more tags and comprising a second processor configured to execute a camera application to:
obtain an image depicting the one or more tags; and
determine location data for each of the one or more tags using the one or more visual attributes indicated in the image based on a predefined schedule for individually scanning the one or more tags or pre-stored visual attributes of the one or more tags; and
a data store configured to register locations of each of the one or more tags by storing the location data for each of the one or more tags with the tag data received from each of the one or more tags based on the predefined schedule or the pre-stored visual attributes of the one or more tags.

7. The inventory system of claim 6, wherein when the locations of each of the one or more tags are registered based on the predefined schedule for individually scanning the one or more tags, the reader application and the camera application are configured to individually scan each tag of the one or more tags and obtain the image depicting the one or more tags according to time intervals indicated in the predefined schedule, and the data store is configured to individually register the location data of the each tag with the tag data received from each tag individually.

8. The inventory system of claim 7, wherein the predefined schedule indicates a frequency at which the reader device and the camera are to communicate with different tags of the one or more tags.

9. The inventory system of claim 6, wherein when the locations of each of the one or more tags are registered based on the pre-stored visual attributes of the one or more tags, the data store is configured to store the visual attributes of each of the one or more tags in association with a tag identifier of each tag prior to the one or more tags entering the inventory environment.

10. The inventory system of claim 9, wherein the inventory system further comprises an application executing on a third processor and configured to compare the one or more visual attributes in the image with the stored visual attributes of each tag to identify the tag identifier for each of the one or more tags depicted in the image, and wherein the data store is configured to register the locations of the each of the one or more tags based on the comparison.

11. The inventory system of claim 9, wherein the pre-stored visual attributes indicate at least one of a pattern of a quick respond (QR) code, a light emitting diode (LED) pattern, colors of the LEDs, brightness of the LEDs, or a background color of each tag of the one or more tags.

12. The inventory system of claim 6, wherein a first tag of the one or more tags comprises an LED, wherein the pre-stored visual attributes of the first tag comprise at least one of the LED when lit, a color of the LED, a brightness of the LED, or a pattern of the LED.

13. A method, comprising:
registering, by an application executing at a computer system in an inventory system, a tag identifier received from a tag in an inventory environment with location data indicating a location of the tag based on a visual attribute of the tag;
initiating, by the application, a scan of the tag to obtain tag data from the tag and to capture an image depicting the tag by transmitting a signal to the tag after registering the tag identifier with the location data of the tag; and
triggering, by the application, activation of a light emitting diode (LED) on the tag to indicate whether a reader device is in a read range of the tag, wherein a visual feature of the LED indicates whether the reader device is in the read range of the tag, and wherein the signal is used to activate the LED on the tag.

14. The method of claim 13, wherein registering, by the application, the tag identifier of the tag with the location data indicating the location of the tag comprises:
initiating, by the application, a prior scan of the tag at a first time according to a predefined schedule to read the tag identifier from the tag;
capturing, by a camera in the reader device, an image depicting the tag and the LED on the tag at the first time according to the predefined schedule;
determining, by the application, the location data of the tag based on a position of the LED on the tag; and
storing, by the application, the tag identifier with the location data at a data store in the inventory system.

15. The method of claim 13, wherein registering, by the application, the tag identifier of the tag with the location data indicating the location of the tag comprises:
initiating, by the application, a prior scan of the tag to read the tag identifier from the tag;
capturing, by a camera in the reader device, an image depicting the tag and the LED on the tag;
determining, by the application, the location data of the tag based on a position of the LED on the tag;
comparing, by the application, a visual attribute of the LED on the tag with a pre-stored visual attribute of a plurality of LEDs on a plurality of different tags stored at a data store in the inventory system to determine the tag identifier corresponding to the visual attribute of the LED of the tag; and
storing, by the application, the tag identifier with the location data at the data store.

16. The method of claim 13, wherein initiating, by the application, the scan of the tag comprises:
transmitting, by the application, the signal to the tag; and
receiving, by the application, the tag data from the tag, wherein the tag data comprises the tag identifier.

17. The method of claim 13, further comprising:
determining, by the application, the location data based on a signal strength of a signal carrying the tag data received from the tag; and
storing, by the application, the location data based on the signal strength in a data store in the inventory system.

18. The method of claim 13, further comprising re-calibrating, by the application, the tag by periodically capturing and storing, by the application, periodic images depicting the tag and the LED on the tag, and receiving, by the application, the tag data from the tag.

19. The method of claim 13, further comprising registering, by the application, a second tag identifier received from a second tag in the inventory environment with the location data indicating the location of the tag based on a rule, wherein the rule indicates that location data for all tags in an area including the location of the tag and a signal strength-based location of the second tag is to be set to the location data of the tag.

20. The method of claim 13, wherein the visual feature of the LED is a predefined color of the LED.
